(19) United States
(12) Patent Application Publication
(10) Pub. No.: US 2025/0256549 A1
(43) Pub. Date: Aug. 14, 2025

(54) SYSTEMS AND METHODS FOR SELECTING BETWEEN POWERING COMPONENTS OF VEHICLES VIA FIRST OR SECOND POWER SOURCES

(71) Applicant: Brunswick Corporation, Mettawa, IL (US)

(72) Inventors: Philip Eadie, Donaghadee (IE); Robert J. Gilmore, Killinchy (IE)

(73) Assignee: Brunswick Corporation, Mettawa, IL (US)

(21) Appl. No.: 18/437,832

(22) Filed: Feb. 9, 2024

(51) Int. Cl. B60H 1/00; B60H 1/22

(52) U.S. Cl. CPC B60H 1/00878; B60H 1/2218; B60H 2001/00928

(57) ABSTRACT

A system for selecting between powering a vehicle component via first or second power sources. First and second lines are configured to be electrically coupled to the first and second power sources, respectively. First and second switches selectively electrically couple the first and second lines to the component, respectively. First and second sensors are configured to detect whether the first line and second lines are receiving power from the first and second power sources, respectively. A controller is configured to control the first switch to electrically decouple the component from the first power source when the second line receives the power from the second power source, and to control the second switch to electrically decouple the component from the second power source when the first line receives the power from the first power source, preventing the component from receiving power from the first and second power sources simultaneously.

### FIELD

The present disclosure generally relates to powering components for vehicles, and more particularly to systems and methods for selecting between powering components of vehicles via first power sources and second power sources.

### BACKGROUND

The present disclosure relates to providing power for components associated with a vehicle. In some cases, the vehicle is configured such that some components associated therewith may be powered via a first power source, and others may be powered via a second power source different than the first power source. Both the first power source and the second power source may provide electrical power, for example with the first power source being AC power from connecting the vehicle to shore power or a conventional power line, and the second power source being DC power provided via a battery bank or another form of energy storage. In the case of ambient air or space heaters, water heaters, or other heaters as the components associated with the vehicle, the heaters may be electrically connected to receive power from the first power source, or electrically connected to receive power from the second power source. For conventional vehicles that are configured to operate from more than one power source, the vehicle includes two separate heaters, one for each of the first and second power sources, respectively, such that heat may be provided whether the vehicle is operating on power from the first power source or from the second power source.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure generally relates to a system for selecting between powering a component of a vehicle via a first power source and a second power source. The system includes a first line configured to be electrically coupled to the first power source and a second line configured to be electrically coupled to the second power source. A first switch selectively electrically couples the first line to the component and a second switch selectively electrically couples the second line to the component. A first sensor is configured to detect whether the first line is receiving power from the first power source and a second sensor is configured to detect whether the second line is receiving power from the second power source. A controller is configured to control the first switch to electrically decouple the component from the first power source when the second line is receiving the power from the second power source. The controller is configured to control the second switch to electrically decouple the component from the second power source when the first line is receiving the power from the first power source so as to prevent the component from receiving power from the first power source and the second power source simultaneously.

In certain examples, the first sensor is a voltage sensor.

In certain examples, a third line is configured to be electrically coupled to a ground associated with the first power source and a fourth line configure to be electrically coupled to a ground associated with the second power source, a third switch selectively electrically couples the component to the third line, and a fourth switch selectively electrically couples the component to the fourth line, where the controller is configured to control the first switch in conjunction with the third switch and to control the second switch in conjunction with the fourth switch.

In certain examples, the first sensor is electrically coupled between the first line and the first switch.

In certain examples, the first sensor and the second sensor are electrically coupled upstream of the first switch and the second switch, respectively, a third sensor is configured to detect whether the first line is receiving power from the first power source downstream of the first switch, and a fourth sensor is configured to detect whether the second line is receiving power from the second power source downstream of the second switch.

In certain examples, the component is a heater, and the controller is configured to control operation of the heater based on whether the heater is receiving the power from the first power source or the second power source. In certain examples, the first power source is DC power and the second power source is AC power. In certain examples, the heater includes a first resistive heating element and a second resistive heating element operable simultaneously to generate heat. In certain examples, the heater includes an additional one or more switches operable to select between the first resistive heating element and the second resistive heating element being electrically coupled in series or in parallel, where the controller is configured to operate the additional one or more switches based on whether the heater is receiving the power from the first power source or the second power source. In certain examples, the first resistive heating element and the second resistive heating element have different resistances from each other, and the different resistances are selected such that the power provided via the first power source when electrically coupled to the heater is within 20% of the power provided via the second power source when electrically coupled to the heater.

Another aspect according to the present disclosure generally relates to a method for powering a component of a vehicle connectable to a first power source and a second power source. The method includes determining whether a first side of a first switch is receiving power from the first power source, and determining whether a first side of a second switch is receiving power from the second power source. The method further includes preventing, via a controller, the first switch from electrically coupling the component to the first power source when the second switch is receiving the power from the second power source, and preventing, via the controller, the second switch from electrically coupling the component to the second power source when the first switch is receiving the power from the first power source.

In certain examples, the first power source is DC power and the second power source is AC power, and the method further includes electrically coupling the component to the second power source when the first side of the first switch is determined to not be receiving the power from the first power source.

In certain examples, the method further includes determining whether a second side of the first switch is receiving power from the first power source, and determining whether a second side of the second switch is receiving power from the second power source. The method further includes preventing, via the controller, the first switch from electrically coupling the component to the first power source when the second side of the second switch is receiving the power from the second power source, and preventing, via the controller, the second switch from electrically coupling the component to the second power source when the second side of the first switch is receiving the power from the first power source. In certain examples, the method further includes electrically coupling the component to the second power source when both the first side and the second side of the first switch are determined to not be receiving the power from the first power source.

In certain examples, the method further includes receiving a default selection among the first power source and the second power source and, when the default selection is the first power source and the first side of the second switch is determined to not be receiving the power from the second power source, causing the first power source to provide the power to the first switch and electrically coupling the component to the first power source to be powered thereby. In certain examples, the first power source comprises a battery system and the method further includes monitoring a state of charge of the battery system and, when the state of charge is below a threshold value, causing the first power source to stop providing the power to the first switch and causing the second power source to provide the power to the second switch.

In certain examples, the first power source is AC power and the second power source is a battery system, whereby a state of charge of the battery system is preserved by defaulting to the component receiving the power from the AC power.

In certain examples, the component is a heater, further comprising controlling operation of the heater based on whether the heater is receiving the power from the first power source or the second power source. In certain examples, the heater includes a first resistive heating element and a second resistive heating element operable simultaneously to generate heat, and the heater includes an additional one or more switches operable to select between the first resistive heating element and the second resistive heating element being electrically coupled in series or in parallel, the method further including controlling the additional one or more switches based on whether the heater is receiving the power from the first power source or the second power source.

Another aspect according to the present disclosure generally relates to a system for heating a vehicle via a first power source and a second power source. A heater has a first resistive heating element and a second resistive heating element having different resistances and being operable simultaneously to generate heat. A first switch selectively electrically couples the heater to the first power source and a second switch that selectively electrically couples the heater to the second power source. At least one additional switch is operable to select between the first resistive heating element and the second resistive heating element being in parallel or in series. A first sensor is configured to detect whether a first side of the first switch is receiving power from the first power source, a second sensor configured to detect whether a first side of the second switch is receiving power from the second power source, a third sensor configured to detect whether a second side of the first switch is receiving power from the first power source, and a fourth sensor configured to detect whether a fourth side of the second switch is receiving power from the second power source. A controller is configured to prevent the first switch from electrically coupling the heater to the first power source when the first side and/or the second side of the second switch is receiving the power from the second power source, configured to prevent the second switch from electrically coupling the heater to the second power source when the first side and/or the second side of the first switch is receiving the power from the first power source, and configured to control the at least one additional switch based on which of the first power source and the second power source is electrically coupled to the heater.

It should be recognized that the different aspects described throughout this disclosure may be combined in different manners, including those than expressly disclosed in the provided examples, while still constituting an invention accord to the present disclosure.

Various other features, objects and advantages of the disclosure will be made apparent from the following description taken together with the drawings.

### BRIEF DESCRIPTION OF THE DRAWINGS

FIG. 1 is a sectional side view of a heater for a vehicle, the heater being configured to be selectively powered via first and second power sources according to the present disclosure.

FIG. 2 is a schematic view of a heating system for a vehicle as known in the art, which has a separate heater for each of the first and second power sources.

FIG. 3 is a schematic view of one example of a system according to the present disclosure for selecting between powering a component via the first and second power sources.

FIG. 4 is a schematic view of one example of a controller for controlling a system such as shown in FIG. 3 according to the present disclosure.

FIG. 5 is a schematic view of one example of heater electronics according to the present disclosure, which may be incorporated within the component of FIG. 3.

FIG. 5 is a schematic view of one example of heater electronics configured to be selectively powered via the first and second power sources according to the present disclosure, which may be incorporated within the component of FIG. 3.

FIG. 6 is a schematic view of another example of heater electronics configured to be selectively powered via the first and second power sources according to the present disclosure, which may be incorporated within the component of FIG. 3.

FIG. 7 is a flow chart depicting one method for selectively powering a component via the first and second power sources according to the present disclosure.

### DETAILED DESCRIPTION

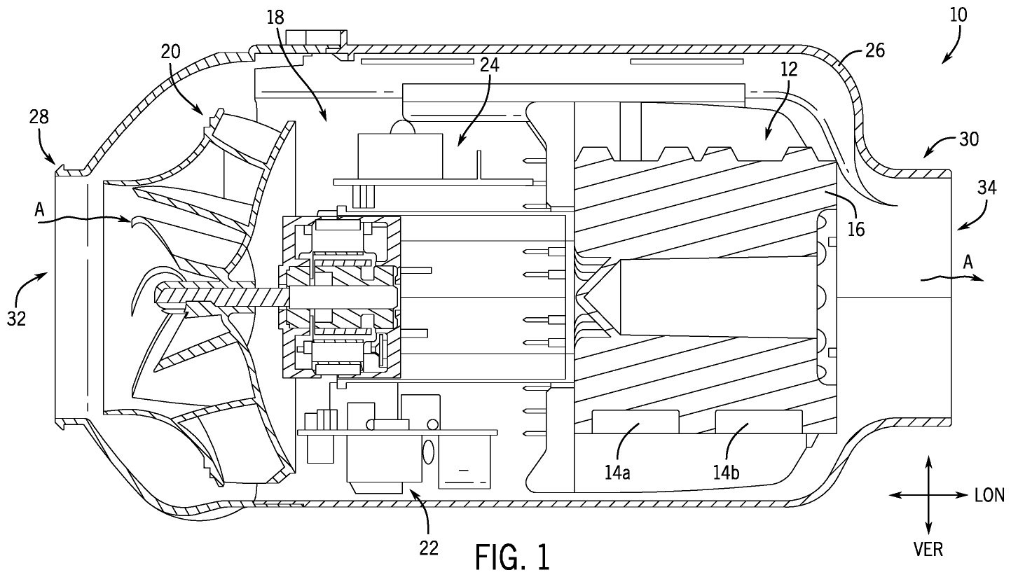

FIG. 1 depicts a heater 10 according to the present disclosure. The electric space heater 10 includes a heating assembly 12 comprising resistive heating elements 14a, 14b and a heat exchanger 16. The heater 10 further includes a motor 18 operatively coupled to a fan 20 such that the motor 18 rotates to turn the fan 20 and generate airflow therewith. A motor controller 22 is electrically coupled to the motor 18 to control the operation thereof. A power supply controller 24 is electrically coupled to the heating assembly 12 and to the motor controller 22 to control the operation thereof, respectively.

The components within the heater 10 are housed within a casing 26 that extends longitudinally between a first end 28 and a second end 30 having a first opening 32 and a second opening 34 therein (also referred to as an inlet and an outlet). In use, the heating assembly 12 generates heat when power is provided to the resistive heating elements 14a, 14b, which are configured to transfer heat to the heat exchanger 16. The motor 18 is operated to rotate blades of the fan 20, thereby moving air A through the casing 26 from the first end 28 to the second end 30. As the air A moves through the heat exchanger 16, the air A is heated from the heat generated by the resistive heating elements 14a, 14b and exits the casing 26 via the second opening 34 at the second end 30. The heat exchanger 16, motor 18, fan 20, and casing 26 may be similar to those generally known in the art for conventional heaters.

It should be recognized that the first end 28 and the second end 30 of the casing 26 are configured to be fluidly connected to ducts within the vehicle, for example to an air inlet and a heating duct system within a recreation vehicle (RV). Since this ductwork may be conventional, further discussion is not provided herein.

The present inventors have recognized that conventional space heaters are not well suited for use in modern vehicles. In particular, legislation, environmental concerns, technology advances, and operator preferences have and continue to push vehicles, including the recreational vehicle (RV) market, away from the use of fossil fuels and towards the use of electric-based power. This includes the use of electric power for heating.

However, this new demand presents a problem for conventional heating systems. For a conventional RV configured to provide heat via two different power sources, these power sources are typically AC power and gas. For example, an RV may be configured to operate via AC power (120 VAC/230 VAC) when situated at a campsite, running on “shore power”. This preserves the fuel for the gas powered heat system, for example liquid propane. However, the same RV must be operable via stored sources of power when shore power is unavailable, for example when camping in remote areas or otherwise operating off the grid. In the case of conventional space heaters, which are typically required for operator comfort whether plugged into the grid or operating off the grid, this means having two separate space heaters installed within the RV: a first that operates on the first source of power (e.g., 120 VAC), and a second space heater that operates on the second source of power (e.g., liquid propane gas).

Some RVs may be outfitted with a separate space heater than operates on DC power (e.g., via a 12 VDC battery), which may be provided as an alternative or in addition to either of the power sources described above. In this case, a completely separate heater is again required (e.g., a DC heater, an AC heater, and/or gas powered heater).

While these separate space heaters may be coupled to the same ductwork within the vehicle, they operate independently. In other words, each space heater necessarily has its own power controllers, heating electronics and assemblies, motors, and fans configured to operate off the corresponding type, voltage, amperage, and frequency of power being supplied thereto, and/or additional plumbing and valves in the case of gas powered heaters. As such, being configured to heat via two different power sources effectively doubles the component cost, cost of installation, weight, complexity, and space required to provide a vehicle with heating, versus for vehicles that only operate off a single source of power.

It should be recognized that while some electrical components are configured to operate at multiple input voltages, such as a laptop having a power adapter configured to operate either at 120 VAC or 230 VAC to enable international travel and the like. However, it must be noted that in each case the laptop is receiving and operating on AC power. There are additional distinctions in the context of components for a vehicle, which are hardwired rather than portable devices and not subject to the same needs for international travel and the like. Accordingly, the present inventors have developed the presently disclosed systems and methods for selecting between powering a single component of a vehicle via either a first power source or a second power source as desired and as available, as well as systems and methods for heating vehicles via these first and second power sources.

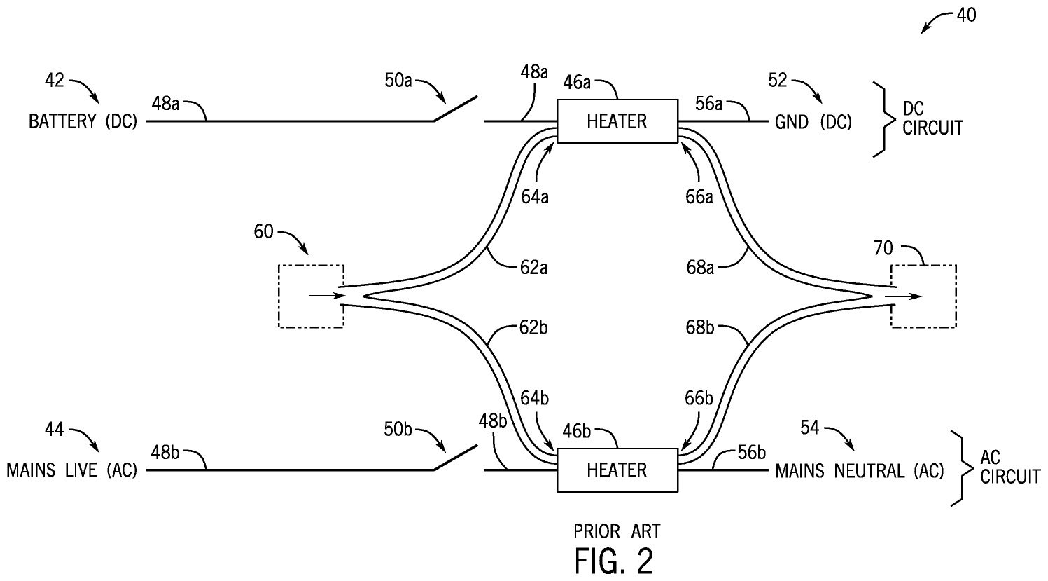

FIG. 2 depicts a conventional heating system 40 for RVs known in the art, and particularly a system configured to operate via both a DC power source 42 and an AC power source 44. As discussed above, since heaters known in the art are limited to operating via a single type, voltage, and current of power, two different heaters are required. In particular, a DC heater 46a is electrically coupled to the DC power source 42 via a DC line 48a, which in the present embodiment is selectively connected via a DC switch 50a. Additionally, an AC heater 46b is electrically coupled to the AC power source 44 via an AC line 48b, which in the present embodiment is selectively connected via an AC switch 50b. It should be recognized that the DC heater 46a and the AC heater 46b are each also electrically coupled to corresponding grounds or neutral contacts 52, 54 to complete the corresponding circuits, here via additional lines 56a, 56b, respectively. For brevity, the entire electrical pathway between a given power source and a component receiving that power, such as space heater or water heater, is referred via a single reference number (e.g., DC line 48a). If further specificity is required, these lines may be described in relation to the various components connected thereby (e.g., between a switch and a sensor, etc.).

Since the heaters 46a, 46b are merely conventional, further discussion is not provided herein. For the sake of brevity, it should be recognized that the heaters 46a, 46b have corresponding resistive elements therein that when powered by the DC power source 42 or the AC power source 44, respectively, generate heat.

FIG. 2 also depicts one configuration for fluidly coupling the heaters 46a, 46b within an RV in a manner known in the art. While the present example shows the heaters 46a, 46b being fluidly coupled in parallel, it should be recognized that they may also be provided in series. Each of the heaters 46a, 46b is fluidly coupled to inlet ductwork 60, here via individual inlet lines 62a, 62b fluidly coupled to inlets 64a, 64b of the heaters 46a, 46b. The input ductwork 60 may include an inlet vent within a wall, floor, ceiling, or elsewhere within an RV. Similarly, each of the heaters 46a, 46b is fluidly coupled to outlet ductwork 60, here via individual outlet lines 62a, 62b fluidly coupled to outlets 64a, 64b of the heaters 46a, 46b. The input ductwork 60 may include an outlet vent within a wall, floor, ceiling, or elsewhere within the RV.

In this manner, the heaters 46a, 46b provide parallel systems for receiving air via the inlets 64a, 64b, heating the air via the heating elements within the heaters 46a, 46b depending upon which power source 42, 44 is available, and outputting the heated air via the outlets 66a, 66b to thereby heat the RV. The heaters 46a, 46b are independently powered and operated, resulting in many redundancies as discussed above. For example, the heaters 46a, 46b each have separate heating elements, separate fans, separate motors, separate casings, and separate inlets and outlets.

Another disadvantage of the system 40 shown in FIG. 2 is that the DC circuit and the AC circuit must be manually controlled, and separately. For example, if the operator connects the RV to the AC power source 44, that operator must not only turn on the AC circuit such that the AC heater 46c can produce heat (e.g., turn on the AC switch 50b), but also turn off the DC circuit (e.g., turn off the DC switch 50a). If the operator forgets to disable the DC circuit, which is easy to do since the goal of heating the RV is being met, the charge of the DC power source 42 can be inadvertently depleted. The present inventors have further recognized that the systems and methods described herein advantageously permit automatic control to vary as a function of the particular components. For example, the system may operate to avoid the use of battery power when the batteries are below 50% for lead acid batteries, versus below 20% for lithium ion batteries, recognizing their differences in chemistry and optimal storage levels.

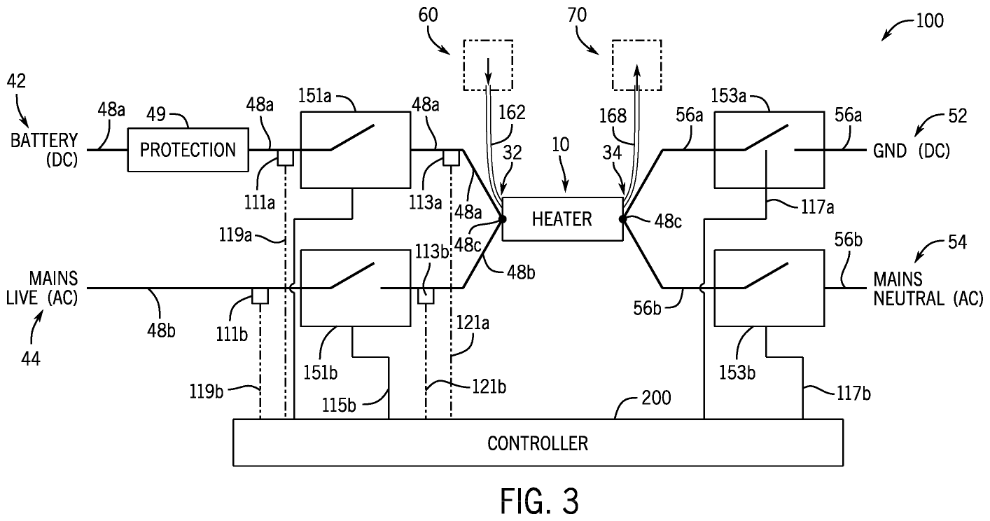

FIG. 3 shows a system 100 according to the present disclosure that may be used to produce the same functions as the system 40 of FIG. 2, but without the disadvantages described above. By way of example, the system 100 of FIG. 3 may be used for heating ambient air, heating water, heating an oven or stovetop, or other types of heating within a vehicle such as an RV. For convenience, FIG. 3 will be described as a system including an electric space heater such as the heater 10 shown in FIG. 1. As will be discussed further below, the same, single heater 10 is operable via AC power received from the AC power source 44, or via DC power received from the DC power source 42, depending upon which is available at the time.

For brevity, elements in the example of FIG. 3 that are the same as those of FIG. 2 are shown with like reference numbers. This makes clear that the system 100 of FIG. 3 may be a replacement for the prior art system of FIG. 2, either for new manufacturing, repair/replacements, or retrofits. Since the system 100 of FIG. 3 has a heater 10 that is operable via AC or DC power, the heater 10 can be fluidly connected to the inlet ductwork 60 and the outlet ductwork 70 of the vehicle via a single inlet line 162 and a single outlet line 168, which are fluidly coupled the openings 32, 34 of the heater 10.

From the electrical perspective, the heater 10 is again coupled to the DC power source 42 and corresponding ground 52 via lines 48a, 52, and likewise to the AC power source 44 and corresponding neural contact 54 via lines 48b, 56b. Protection circuitry 49 is provided between the DC power source 42 and the heater 10, which may include fuses and the like to protect the batteries or other elements within the DC circuit. It should be recognized that the liens 48a, 48b may merge (e.g., connection 48c) to be electrically coupled to the heater 10 at a single contact.

Switches are again provided for selectively completing the circuits for the DC power source 42 and for the AC power source 44. However, in the system 100 of FIG. 100, there are switches for controlling the flow of DC power and AC power both upstream and downstream of the heater 10. For convenience, these switches are referred to as upstream and downstream DC switches 151a, 153a and upstream and downstream AC switches 151b, 153b, respectively. These switches 151a, 151b, 153a, 153b may comprise MOSFET transistors, relays, and/or other types of known electrical switches. The switches within the DC circuit (151a, 153a), and likewise the switches within the AC circuit (151b, 153b), may also be referred to as a single switch, respectively. Beyond referring to a single switch for brevity, it should be recognized that the present disclosure contemplates different configurations of switches to provide the same functions described herein (e.g., two separate switches may be combined into a single double pole, single throw switch). Likewise, a single relay may provide switching functionality for switches 151a and 153a together. In other embodiments, having multiple separate switches may be advantageous for further redundancy in the event of sensor or switch failures.

The system 100 of FIG. 3 further includes sensors 111a, 111b configured to detect whether the DC line 48a is receiving power from the DC power source 42, and whether the AC line 48b is receiving power from the AC power source 44, respectively. In certain configurations the sensors 111a, 111b are conventional voltage sensors, current sensors, or others configured to measure whether power is being provided to the switches 151a, 151b. In certain configurations, including that shown in FIG. 3, the sensors 111a, 111b are electrically coupled within the system 100 upstream of the switches 151a, 151b, whereby the system 100 further includes sensors 113a, 113b (also referred to as downstream switches) configured to detect whether DC power from the DC line 48a is being received downstream of the DC switch 151a, and whether AC power from the AC line 48b is being received downstream of the AC switch 151b, respectively. In other words, the upstream sensors 111a, 111b determine whether the DC power source 42 and/or the AC power source 44 is operating and providing power to the system 100. Likewise, the downstream sensors 113a, 113b determine the DC power switch 151a and the AC power switch 151b are closed and thus passing DC power and/or AC power from the DC power source 42 and/or the AC power source 44 for use by the heater 10. As is discussed further below, this provides a safeguard to ensure that power from both the DC power source 42 and the AC power source 44 are not provided to the heater 10 at the same time, even in the event of a failure of one of the switches 151a, 151b.

The system 100 further includes a controller 200 that is provided in communication with the switches 151a, 151b, 153a, 153b via lines 115a, 115b, 117a, and 117b, and also with the sensors 111a, 111b, 113a, and 113b via lines 119a, 119b, 121a, and 121b. The controller 200 also communicates with an additional switch 160 for changing whether the component of interest, hear the heater 10, is configured to operate receiving power from the DC power source 42, or receiving power from the AC power source 44, as discussed further below.

The controller 200 is configured to electronically controlled to the switches 151a, 151b, 153a, 153b (and switch 160) based on the measurements or data provided by the sensors 111a, 111b, 113a, and 113b, respectively. The control logic for the controller 200 is further discussed below. In certain examples, the controller 200 is configured to control the DC switches 151a, 153a to electrically decouple the heater 10 from the DC power source 42 when power is detected as being received from the AC power source 44, and to control the AC switches 151b, 153b to electrically decouple the heater 10 from the AC power source 44 when power is detected as being received from the DC power source 42. In other words, the controller 200 is operable to selectively move the switches 151a, 151b, 153a, 153b (as well as a switch 160, discussed below) between opened and closed positions to effectuate whether DC or AC power flows to the heater 10. In addition to switching the circuitry to function off AC power or DC power, depending upon which is available, the present inventors have advantageously configured the presently disclosed systems and methods such that the component to be powered (e.g., a space heater) is prevented from receiving power from the DC power source 42 and the AC power source 44 simultaneously. It should be recognized that while the controller 200 is shown as a single device, the functions of the controller may be divided across multiple elements.

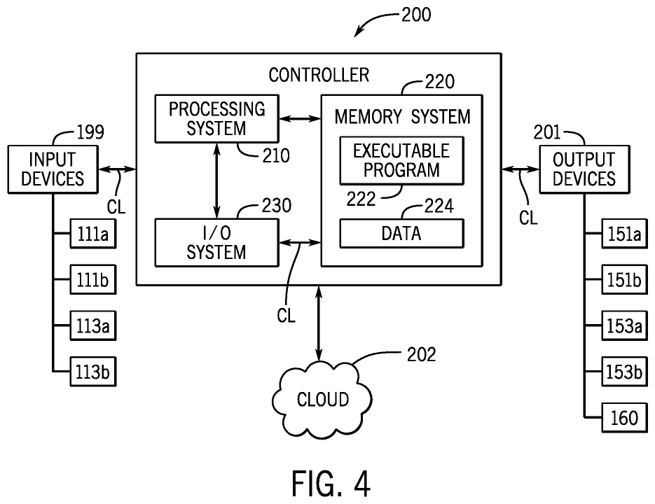

An exemplary controller 200 is shown in FIG. 4. Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples, the control system 200 communicates with each of the one or more components of the system 100 via a communication link CL, which can be any wired or wireless link. The control system 200 is capable of receiving information and/or controlling one or more operational characteristics of the system 100 and its various sub-systems by sending and receiving control signals via the communication links CL. In one example, the communication link CL is a controller area network (CAN) bus; however, other types of links could be used. It will be recognized that the extent of connections and the communication links CL may in fact be one or more shared connections, or links, among some or all of the components in the system 100. Moreover, the communication link CL lines are meant only to demonstrate that the various control elements are capable of communicating with one another, and do not represent actual wiring connections between the various elements, nor do they represent the only paths of communication between the elements. Additionally, the system 100 may incorporate various types of communication devices and systems, and thus the illustrated communication links CL may in fact represent various different types of wireless and/or wired data communication systems.

The control system 200 may be a computing system that includes a processing system 210, memory system 220, and input/output (I/O) system 230 for communicating with other devices, such as input devices 199 and output devices 201, either of which may also or alternatively be stored in a cloud 202. The processing system 210 loads and executes an executable program 222 from the memory system 220, accesses data 224 stored within the memory system 220, and directs the system 100 to operate as described in further detail below.

The processing system 210 may be implemented as a single microprocessor or other circuitry or be distributed across multiple processing devices or sub-systems that cooperate to execute the executable program 222 from the memory system 220. Non-limiting examples of the processing system include general purpose central processing units, application specific processors, and logic devices.

The memory system 220 may comprise any storage media readable by the processing system 210 and capable of storing the executable program 222 and/or data 224. The memory system 220 may be implemented as a single storage device or be distributed across multiple storage devices or sub-systems that cooperate to store computer readable instructions, data structures, program modules, or other data. The memory system 220 may include volatile and/or non-volatile systems and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

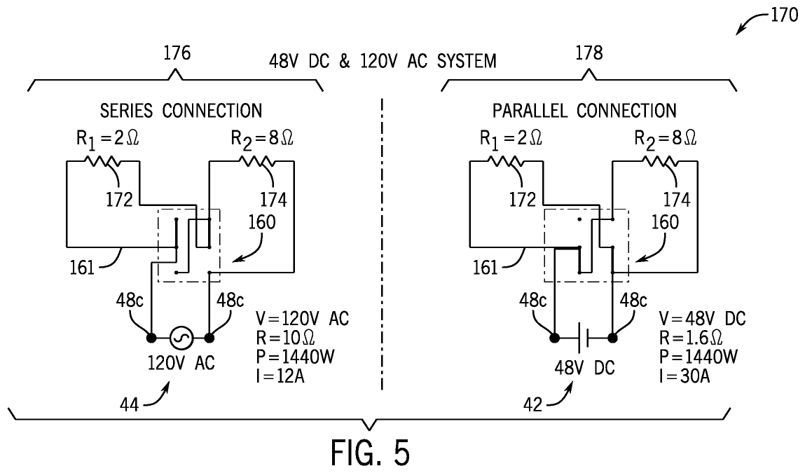

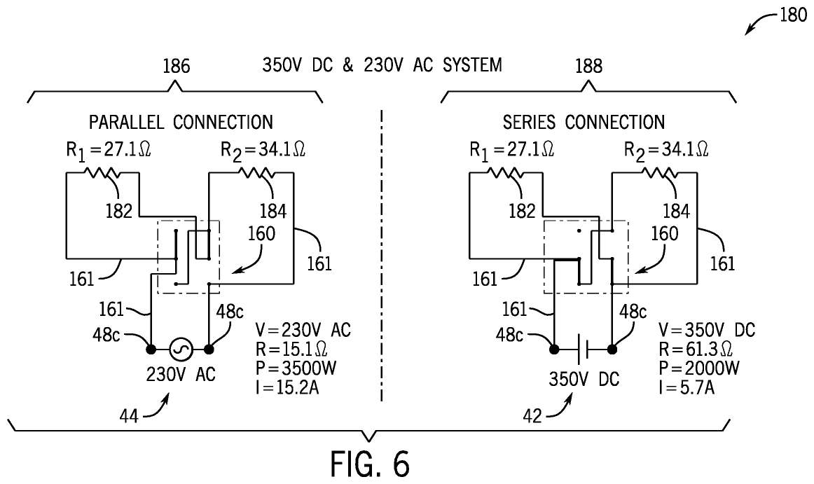

FIGS. 5 and 6 depict two different embodiments of heating electronics 170, 180 within the heating assembly of different heaters according to the present disclosure, which may be controlled via the controller 200 discussed above. It should be recognized that the heating electronics 170, 180 may be incorporated within the heating assembly 12 of the heater 10 of FIG. 1, for example. The example of FIG. 5 depicts resistive heating elements 172, 174 as the resistive heating elements 14a, 14b shown in the heater 10 of FIG. 1, in this case being resisters having a resistance of 2 ohms and 8 ohms, respectively. The example of FIG. 6 depicts resistive heating elements 182, 184 as the resistive heating elements 14a, 14b shown in the heater 10 of FIG. 1, in this case being resisters having a resistance of 27.1 ohms and 34.1 ohms, respectively. Switches 160, such as MOSFETs and/or relays, are operable to change whether the resistive heating elements 172, 174, and likewise resistive heating elements 182, 184, are connected in series to each other, or in parallel to each other. The controller 200 is operatively coupled to control the switches 160 in this manner, which as discussed above may be based on feedback received from the various sensors 11a, 111b, 113a, 113b and switches 151a, 151b, 153a, 153b, also discussed further below.

For the heating electronics 170, 180 or FIGS. 5 and 6, the first circuit diagrams 176, 186 shown on left depict the switches 160 positioned to operate via AC power, whereas the second circuit diagrams 178, 188 shown on right depict the switches 160 positioned to operate via DC power. For the heating electronics 170 of FIG. 5, the first circuit diagram 176 corresponds to the switch 160 being positioned such that the resistive heating elements 172, 174 are electrically connected via wires 161 in series, which in this case is connected for operating via AC power. In other words, power flows through the first circuit diagram 176 from the AC power source 44, through the resistive heating element 172, and through the resistive heating element 174 all in series. The second circuit diagram 178 corresponds to the switch 160 being positioned such that the resistive heating elements 172, 174 are electrically connected in parallel, which in this case is connected for operating via DC power. In this case, power flows through the second circuit diagram 178 from the DC power source 42 through the resistive heating element 172 in parallel to the power flowing from the DC power source 42 through the resistive heating element 174 all in series.

Based on the particular resistive heating elements selected, operating the heating electronics 170 of FIG. 5 via an AC power source 44 providing 120 VAC results in the resistive heating elements 172, 174 having a combined effective resistance of 10 ohms, a current within the circuit of 12 amps, and a power through the heating electronics 160 of 1440 watts. The second circuit diagram 178 shows the same heating electronics 170 when the via switch 160 have been controlled to make power flow to the resistive heating elements 172, 174 in parallel, and in this case from a DC power source 42 providing 48 VDC. In this case, the combined effective resistance of the resistive heating elements 172, 174 is 1.6 ohms and a current of 30 amps. In this configuration, the heating electronics 170 are provided such that the same power of 1440 watt is also provided when operating on DC power, which is advantageous in therefore providing the same or similar heating under either power source (e.g., within 50%, 30%, 25%, 20%, 15%, 10%, or 5% power of each other). In this manner, the presently disclosed systems and methods are further advantageous in that the operator may select among the different power sources without having to consider or weigh the impacts on heat capacity and performance.

The heating circuit 180 shown in FIG. 6 is configured such that, in contrast to that of FIG. 5, the resistive heating elements 186, 188 are controlled, via switch 160, to be electrically coupled in parallel when receiving power from an AC power source 44, and in series when receiving power from a DC power source 42. In this configuration, the heating circuit 180 is shown operating with 230 VAC (first circuit diagram 186) and 350 VDC (second circuit diagram 188). When the resistive heating elements 182, 184 are electrically coupled to the AC power supply 44 in parallel, the combined effective resistance is 15.1 ohms with 15.2 amps flowing therethrough, resulting in 3500 watts of power. When the resistive heating elements 182, 184 are switched via switch 160 to be electrically coupled to the DC power supply 44 (thus, in series), the combined effective resistance is 61.3 ohms with 5.7 amps flowing therethrough, resulting in 2000 watts of power.

It should be recognized that the present disclosure also contemplates other resistance values and configurations of resistive heating elements versus those expressly shown. These can be selected, in absolute and/or relative terms, to accommodate different voltage and/or current capabilities by the various power sources, to provide the desired amounts of heating under each type of power source, and/or other considerations. As such, the presently disclosed system and methods not only provide for safe switching between power sources, but flexibility in configuring the systems to operate under many different conditions and in many different contexts, such as an electric RV operable under battery power or AC mains.

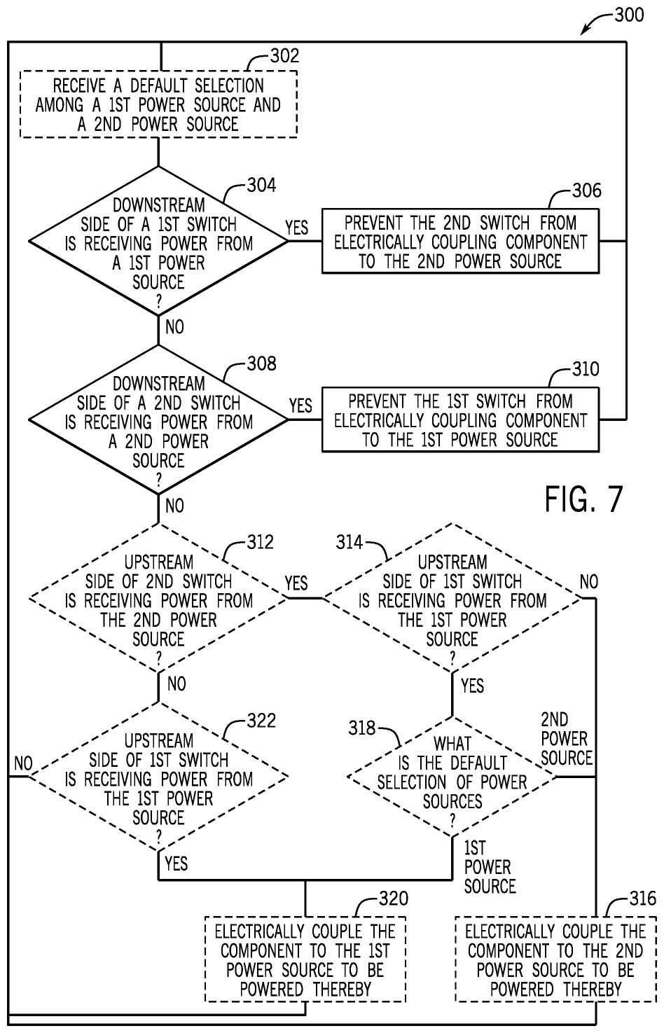

FIG. 7 shows a flow chart for one example of a method 300 for powering a component of a vehicle connectable to a first power source and a second power source, such as a space heater, water heater, kitchen appliance, and/or other devices configured to produced heat via resistive elements. By way of non-limiting example, this method 300 may be used for an electric RV configured to selectively receive power from an AC power source at some times, and from a DC power source at other times. In certain examples, the method 300 includes the optional step 302 of receiving a default selection for whether to use DC power or AC power when both sources are available. This default selection is then referenced in other optional steps, which are discussed further below.

Step 304 provides for determining whether a downstream side of a first switch is receiving power from a first power source. With reference to the exemplary system 100 of FIG. 3, the first switch may be the switch 151a, the first power source may be the DC power source 42, and the determination of whether the downstream side of the first switch is receiving power may be determined via the sensor 113a (e.g., a voltage sensor electrically coupled to the controller 200). The sensor 113a may measure the voltage and communicate with the controller 200 (e.g., transmit signals, send data, and the like) in a manner known in the art. If the downstream side of the first switch is determined to be receiving power from the first power source, meaning that the first switch is closed and/or otherwise conducting power therethrough (including in the case of a failure or other shorting of the first switch), step 306 provides for preventing a second switch from electrically coupling a component to a second power source. In the example of FIG. 3, the second switch may be the switch 151b, the second power source may be the AC power source 44, and the component may be the heater 10. In this manner, step 306 prevents both power sources from being coupled to the component at the same time. As discussed above, this provides a fail-safe in the event that the system has requested that the first switch be opened, but the first switch is somehow still conducting power from the first power source therethrough.

If instead the downstream side of the first switch is not deemed to be receiving power in step 304, the method proceeds to step 308, which determines whether the downstream side of the second switch is receiving power from the second power source. If so, similar to step 306, step 310 provides for preventing the first switch from electrically coupling the component to the first power source, thereby preventing the component from being coupled to both power sources at the same time as they feel safe. If instead in step 308 it is determined that the downstream side of the second switch is not receiving power from the second power source, in certain embodiments the method 300 restarts, whereas in others, including the one shown in FIG. 7, the process continues to step 312. Step 312 provides for determining whether an upstream side of the second switch is receiving power from the second power source. With reference to the example of FIG. 3, the upstream side of the second switch maybe measured via the sensor 111b, which again may be a conventional voltage sensor or other sensor known in the art. If it is determined in step 312 that the upstream side of the second switch is indeed receiving power from the second power source, the process continues to step 314 which determines whether an upstream side of the first switch is receiving power from the first power source. In the example of FIG. 3, the upstream side of the first switch may be measured via the sensor 111a, which may be the same as the sensor 111b or other sensors described herein.

If the upstream side of the first switch is determined to be receiving power from the first power source in step 314, the method continues to optional step 316, specifically electrically coupling the component to the second power source such that the component is powered thereby. In other words, step 316 provides that if there is upstream power for the second switch, but not for the first switch, power is only available from the second power source and thus the component should be electrically coupled to be powered by that second power source. If instead in step 314 it is determined that the upstream side of the first switch is receiving power from the first power source, method continues to step 318, which determines what the default selection of power source is when more than one power source is available, which as discussed above was provided in optional step 302. If instead in step 318 it is determined that the second power source is the default selection, the process again proceeds to step 316 since power is available from the second power source, and the second power source is the preferred default selection.

If instead in step 318 it is determined that the first power source is the default selection among the power sources, the method continues to step 320, particularly electrically coupling the component to the first power source to be powered thereby. In other words, step 320 provides that if power is available from both the first power source and the second power source, and the default selection is the first power source, the component will be operated via the 1st power source.

Returning to step 312, if it is determined that the upstream side of the second switch is not receiving power from the second power source, the process continues to step 322, which determines whether the upstream side of the first switch is receiving power from the 1st power source. If not, the process returns to the start. However, if the upstream side of the first switch is determined to be receiving power from the first power source in step 322, process continues to step 320, which has described above provides for electrically coupling the component to the first power source to be powered thereby.

In certain embodiments, the present disclosure further provides for generating notifications or warnings to the operator when various conditions occur. By way of example, a display device provided as an output device 199 to the controller 200 (see FIG. 4), such as touchscreen or non-touchscreen display known and operable in a manner known in the art, may generate a notification when one or more switches are controlled to prevent the component from being coupled thereto. Likewise, a warning may be generated via the display device, speakers, haptic devices, or other devices when a switch is supposed to be off, but a downstream sensor determines that power is nonetheless passing through that switch.

Similar notifications may also or alternatively be provided when both power sources are available, such that the operator knows that they have choices available for powering the components. For example, whereas in many cases a system will be configured to operate with AC power as the default selection whenever available (e.g., to preserve battery charge), it may instead be preferable to operate off of DC power during daytime hours when solar panels are available for green and free energy. In this case, the operator may manually override the default selection, change the default selection, and/or create or choose a schedule and/or set of conditions for which the default selection may vary. This schedule or set of conditions may be chosen or inputted via a touchscreen display acting as an input device 199 (and an output device 201) to the controller 200 (see FIG. 4). For example, the operator may schedule the default selection to be the AC power source between the hours of 8:00 pm and 6:00 am (which may further vary by calendar date and/or geographic region), when a measured voltage or current of a solar panel is below a certain threshold (e.g., 50% or less than maximum charging power), and/or when the state of charge of the battery system is below a certain threshold (e.g., 50% of full charge). The system may also notify the operators when the schedule or conditions cause the default selection to change, such as from a schedule time or change in charging power from a solar panel.

It should be recognized that while the disclosure primarily provided examples of having two power sources, more are contemplated by the present disclosure via the addition of further resistive heating elements, electrical pathways, and switches to control which of these resistive heating elements are powered, and how they are electrically coupled at a given instance (e.g., a first resistive heating element being in parallel with second and third resistive heating elements that are in series with each other). In this case, the system may be configured to operate via AC power when coupled to shore power, under a first DC power source when operating via a battery bank, and via solar panels, wind turbines, and/or hydrogenerators (in the case of marine vehicles) depending on which energy source is available, preferred, and/or is optimal for use.

In this manner, the presently disclosed systems and methods provide for singular components that are intelligently operable via two or more power sources. As discussed above, this simplifies the process of managing of operating the vehicle for the operator, provides for intelligent and safe switching between power sources, and reduces the cost, complexity, space, and the like for producing and maintaining the vehicle.

The present inventors have identified further advantages to the presently discloses systems and methods over those known in the art. For example, an RV known in the art may be configured to would use AC to charge a DC battery via charger. An AC heater may be provided for heating the RV, which can be directly powered when plugged into the grid, or powered via the DC battery through use of an inverter. Inverters add complication, expense, and a further point of weakness for failure over time. The presently discloses systems and methods would allow the inverter to be eliminated in certain cases, particularly by allowing the heater to run on DC power directly.

Additionally, chargers and inverters have limited power capacity, such as a maximum power output of 5 kW. Heaters are typically the most demanding components powered by the inverter, thereby greatly impacting the minimum requirements of the RV's inverter. Thus, even if an inverter is still needed or desired for other functions of the RV, the presently disclosed systems and methods would allow manufacturers and operators to install inverters having lower capacity, saving cost and weight. In addition, or as an alternative benefit, a smaller inverter can then operate more components at the same time that the heater is in operation, which may otherwise have blown a circuit in a conventionally known system. For example, use of hair dryers, ovens, or microwaves may be limited or restricted while the heater is operating, or operating on high.

Further advantageous and improvements are also enabled by the smart systems and methods described herein. For example, the systems may be controlled or monitored via a mobile device operating an app (e.g., through a cloud service such as Amazon's AWS). This allows an operator to modify the heating or other operations of the RV while away (e.g., to turn up or down the heat depending on projected occupancy). Likewise, the operator may receive warnings regarding power capacity and/or that the RV is not heating in an expected manner (e.g., a door or window must be open if the RV cannot achieve the requested temperate after a preset time, such as 1 hour).

In other configurations, the system may use data from a mobile device to make heating and/or solar charging projections as a function of GPS location (e.g., geo-fencing), expected weather reports, and/or the like. All of these additional functions would not be possible with conventional systems, including those in which two separate heaters much be manually switched between.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A system for selecting between powering a component of a vehicle via a first power source and a second power source, the system comprising:
a first line configured to be electrically coupled to the first power source and a second line configured to be electrically coupled to the second power source;
a first switch that selectively electrically couples the first line to the component and a second switch that selectively electrically couples the second line to the component;
a first sensor configured to detect whether the first line is receiving power from the first power source and a second sensor configured to detect whether the second line is receiving power from the second power source; and
a controller configured to control the first switch to electrically decouple the component from the first power source when the second line is receiving the power from the second power source and wherein the controller is configured to control the second switch to electrically decouple the component from the second power source when the first line is receiving the power from the first power source so as to prevent the component from receiving power from the first power source and the second power source simultaneously.

2. The system according to claim 1, wherein the first sensor is a voltage sensor.

3. The system according to claim 1, further comprising a third line configured to be electrically coupled to a ground associated with the first power source and a fourth line configure to be electrically coupled to a ground associated with the second power source, and further comprising a third switch that selectively electrically couples the component to the third line and a fourth switch that selectively electrically couples the component to the fourth line, wherein the controller is configured to control the first switch in conjunction with the third switch and to control the second switch in conjunction with the fourth switch.

4. The system according to claim 1, wherein the first sensor is electrically coupled between the first line and the first switch.

5. The system according to claim 1, wherein the first sensor and the second sensor are electrically coupled upstream of the first switch and the second switch, respectively, further comprising a third sensor configured to detect whether the first line is receiving power from the first power source downstream of the first switch, and a fourth sensor configured to detect whether the second line is receiving power from the second power source downstream of the second switch.

6. The system according to claim 1, wherein the component is a heater, and wherein the controller is configured to control operation of the heater based on whether the heater is receiving the power from the first power source or the second power source.

7. The system according to claim 6, wherein the first power source is DC power and the second power source is AC power.

8. The system according to claim 6, wherein the heater comprises a first resistive heating element and a second resistive heating element operable simultaneously to generate heat.

9. The system according to claim 8, wherein the heater comprises an additional one or more switches operable to select between the first resistive heating element and the second resistive heating element being electrically coupled in series or in parallel, wherein the controller is configured to operate the additional one or more switches based on whether the heater is receiving the power from the first power source or the second power source.

10. The system according to claim 9, wherein the first resistive heating element and the second resistive heating element have different resistances from each other, and the different resistances are selected such that the power provided via the first power source when electrically coupled to the heater is within 20% of the power provided via the second power source when electrically coupled to the heater.

11. A method for powering a component of a vehicle connectable to a first power source and a second power source, the method comprising:
determining whether a first side of a first switch is receiving power from the first power source, and determining whether a first side of a second switch is receiving power from the second power source; and
preventing, via a controller, the first switch from electrically coupling the component to the first power source when the second switch is receiving the power from the second power source, and preventing, via the controller, the second switch from electrically coupling the component to the second power source when the first switch is receiving the power from the first power source.

12. The method according to claim 11, wherein the first power source is DC power and the second power source is AC power, further comprising electrically coupling the component to the second power source when the first side of the first switch is determined to not be receiving the power from the first power source.

13. The method according to claim 11, the method further comprising:
determining whether a second side of the first switch is receiving power from the first power source, and determining whether a second side of the second switch is receiving power from the second power source; and
preventing, via the controller, the first switch from electrically coupling the component to the first power source when the second side of the second switch is receiving the power from the second power source, and preventing, via the controller, the second switch from electrically coupling the component to the second power source when the second side of the first switch is receiving the power from the first power source.

14. The method according to claim 13, further comprising electrically coupling the component to the second power source when both the first side and the second side of the first switch are determined to not be receiving the power from the first power source.

15. The method according to claim 11, further comprising receiving a default selection among the first power source and the second power source and, when the default selection is the first power source and the first side of the second switch is determined to not be receiving the power from the second power source, causing the first power source to provide the power to the first switch and electrically coupling the component to the first power source to be powered thereby.

16. The method according to claim 15, wherein the first power source comprises a battery system, further comprising monitoring a state of charge of the battery system and, when the state of charge is below a threshold value, causing the first power source to stop providing the power to the first switch and causing the second power source to provide the power to the second switch.

17. The method according to claim 11, wherein the first power source is AC power and the second power source is a battery system, whereby a state of charge of the battery system is preserved by defaulting to the component receiving the power from the AC power.

18. The method according to claim 11, wherein the component is a heater, further comprising controlling operation of the heater based on whether the heater is receiving the power from the first power source or the second power source.

19. The method according to claim 18, wherein the heater comprises a first resistive heating element and a second resistive heating element operable simultaneously to generate heat, and wherein the heater comprises an additional one or more switches operable to select between the first resistive heating element and the second resistive heating element being electrically coupled in series or in parallel, further comprising controlling the additional one or more switches based on whether the heater is receiving the power from the first power source or the second power source.

20. A system for heating a vehicle via a first power source and a second power source, the system comprising:
a heater having a first resistive heating element and a second resistive heating element having different resistances and being operable simultaneously to generate heat;
a first switch that selectively electrically couples the heater to the first power source and a second switch that selectively electrically couples the heater to the second power source;
at least one additional switch operable to select between the first resistive heating element and the second resistive heating element being in parallel or in series;
a first sensor configured to detect whether a first side of the first switch is receiving power from the first power source, a second sensor configured to detect whether a first side of the second switch is receiving power from the second power source, a third sensor configured to detect whether a second side of the first switch is receiving power from the first power source, and a fourth sensor configured to detect whether a fourth side of the second switch is receiving power from the second power source;
a controller configured to prevent the first switch from electrically coupling the heater to the first power source when the first side and/or the second side of the second switch is receiving the power from the second power source, configured to prevent the second switch from electrically coupling the heater to the second power source when the first side and/or the second side of the first switch is receiving the power from the first power source, and configured to control the at least one additional switch based on which of the first power source and the second power source is electrically coupled to the heater.
